(19) United States
(12) Patent Application Publication
(10) Pub. No.: US 2008/0274335 A1
(43) Pub. Date: Nov. 6, 2008

(54) Photolytic Polymer Surface Modification

(75) Inventors: Christopher N. Bowman, Boulder, CO (US); Sirish Reddy, Hills Boro, OR (US); Neil Cramer, Boulder, CO (US); Robert P. Sebra, San Francisco, CA (US); Hui Lu, Dover, DE (US)

Correspondence Address: Don D. Cha, 547 Buena Vista Road, Golden, CO, 80401, US

(73) Assignee: REGENTS OF THE UNIVERSITY OF COLORADO, Boulder, CO (US)

(21) Appl. No.: 11/722,074

(22) PCT Filed: Dec. 16, 2005
(86) PCT No.: PCT/US05/46147

§ 371 Date: Jun. 8, 2008

Related U.S. Application Data
(60) Provisional application No. 60/637,111, filed on Dec. 16, 2004.

(51) Int. Cl. B32B 3/30; C08J 3/28; C08G 75/04

(52) U.S. Cl. 428/167; 528/376; 528/32; 528/364; 528/321; 528/75; 522/134

(57) ABSTRACT

The present invention provides a method for modifying a surface of a polymer derived from a mixture comprising a thiol monomer and an olefinic monomer. The method comprises exposing at least a portion of the polymer surface to electromagnetic radiation of sufficient energy to modify the polymer surface. The present invention also provides a polymer derived from polymerizing a mixture of monomers comprising a thiol monomer, an olefinic monomer, and an iniferter.

### CROSS-REFERENCE TO RELATED APPLICATIONS

This application claims the priority benefit of U.S. Provisional Application No. 60/637,111, filed Dec. 16, 2004, which is incorporated herein by reference in its entirety.

### STATEMENT REGARDING FEDERALLY SPONSORED RESEARCH

The U.S. Government has a paid-up license in this invention and the right in limited circumstances to require the patent owner to license others on reasonable terms as provided for by the terms of Tie Grant No. EEC-0120943 awarded by the National Science Foundation.

### FIELD OF THE INVENTION

The present invention relates to a method for modifying a surface of a polymer derived from a mixture comprising a thiol monomer and an olefinic monomer. The present invention also relates to a polymer derived from polymerizing a mixture of monomers comprising a thiol monomer, an olefinic monomer, and optionally an iniferter.

### BACKGROUND OF THE INVENTION

Conventional techniques for microdevice fabrication on glass and silicon are still the most common, but current research involves developing fully polymeric microdevices. Fully polymeric devices offer durability for field use and clinical diagnostics applications, affordability, and the ability to tailor both chemical and mechanical properties of devices. To date, the most successful fabrication techniques for crosslinked polymer-based microdevices have been soft lithography and microfluidic tectonics. These methods greatly reduce fabrication times to less than 24 hours. While these techniques have proven useful in a number of microfluidics applications, each have its own short comings. For example, soft lithography techniques typically utilize PDMS rubber, which has limited utility as a device material, exhibits poor mechanical integrity with solvent swelling of up to 100%, little resistance to diffusion, and lacks robust surface modification techniques. Microfluidic tectonics enables the integration of various construction materials, but is suitable for mainly single-layer devices. The lack of integrity in these polymer matrices is unfortunate, since the effectiveness of a microdevice relies heavily on materials and surface properties of the device.

The control of surface chemistry, properties, and interactions has become increasingly important for a wide variety of applications. Surface modification is used to integrate surface functionalities on fabricated device substrates and to enhance numerous properties such as adhesiveness, hydrophobicity, biocompatibility, antifouling, surface hardness, and surface roughness. For example, the biocompatibility of biomedical devices or implanted scaffolds is significantly affected by the surface composition and properties. The surface modification of polymeric matrices provides the unique ability to tune and manipulate surface properties without requiring customization of the bulk materials or material properties. Furthermore, surface modification enables the incorporation of multiple surface functionalities, and this is important for the development and optimal performance of functional devices.

Techniques for surface modification are readily divided into three specific types: physical deposition of surface-active compounds, direct coupling reactions of polymers onto surfaces (grafting-to), and grafting of monomers from reactive surfaces (grafting-from). The physical deposition of surface compounds leads to noncovalently bound grafts, and this makes the adsorption a reversible process. Such grafts may be unstable under high shear forces or other adverse chemical and physical conditions. Surface modification via coupling reactions (grafting-to) has several limitations, including incomplete surface coverage, diffusion limitations of the polymers to the surface, and island formation due to steric crowding of the reactive sites by the already grafted polymers. The grafting-from technique, in which grafts are formed through the reaction of monomers from active surfaces, is an attractive alternative for forming robust grafts that provides great control over the density and functionality of the grafts. Current surface modification procedures with the grafting-from approach use techniques such as □-ray irradiation, UV irradiation, plasma treatment, and glow discharge to create radicals or hydroperoxide groups on surfaces, which facilitate further grafting through radical polymerization at elevated temperatures or upon exposure to UV light. Each of these approaches involves grafting through radical polymerization, which inherently encompasses uncontrolled reactions such as termination.

Some conventional photopolymer formulations that exhibit high glass transition temperatures exhibit high shrinkage stresses, while those that form polymers with low shrinkage exhibit low glass transition temperatures. In addition, some of the available polymerization methods are oxygen sensitive (e.g., polymerization reaction is inhibited by oxygen) and achieve low rate of conversion. It is believed that some of these limitations of conventional monomeric mixtures and/or photopolymerization methods are primary due to the self-limiting nature of their reaction mechanisms.

Therefore there is a need for monomer formulations that offer means to form homogenous networks with low shrinkage stress, high glass transition temperatures, allow high rate of conversion, and/or greatly reduced oxygen inhibition.

### SUMMARY OF THE INVENTION

One aspect of the present invention provides a polymer derived from polymerizing a monomer mixture comprising a thiol monomer, an olefinic monomer, and an iniferter.

In some embodiments, the olefinic monomer is an acrylate monomer, a methacrylate monomer, a vinyl ether monomer, an allyl ether monomer, a vinyl silazane monomer, or a mixture thereof.

While virtually any monomeric ratios can comprise polymers of the present invention, in one particular embodiment, the ratio of thiol monomer to olefinic monomer ranges from about 0.01 to about 100.

Polymers of the present invention can be prepared using any conventional methods known to one skilled in the art, such as thermal, photolytic, injection molding, casting, etc. In some embodiments, monomeric mixtures are polymerized using an electromagnetic radiation of sufficient energy. Depending on the monomeric mixture composition, polymerization can be achieved using infrared (IR), visible, ultraviolet (UV), x-ray, or gamma-ray.

Iniferter can be a thermal inifer or a photoiniferter. When further modification of the polymer is contemplated or desired, typically a photoiniferter is used to produce the polymer. This allows modification of the polymer surface by a photolithography process. Regardless of the type of iniferter used, in many embodiments, polymers of the present invention comprises iniferter moieties on the surface.

Another aspect of the present invention provides a method for modifying a surface of a polymer derived from a mixture comprising a thiol monomer and an olefinic monomer. Methods of the present invention comprise exposing at least a portion of the polymer surface to electromagnetic radiation of sufficient energy to modify the polymer surface.

In some methods of the present invention, the monomer mixture used to produce the polymer further comprises a photoiniferter. This allows the polymer surface to comprise photoiniferter moieties, thus allowing modification of the polymer surface using a photolithography process.

In some embodiments, methods of the present invention further comprise covalently attaching a surface modifier to at least a portion of the surface using a photolithography process. This can be achieved by exposing at least a portion of the polymer surface that comprises photoiniferter moieties to electromagnetic radiation of sufficient energy to generate reactive species. When a surface modifying agent is present, the reactive species thus generated reacts with the surface modifying agent to form a covalent bond.

In some embodiments, regardless of whether any iniferter moieties is present on the polymer surface or, preferably not, exposing the polymer surface of the present invention to electromagnetic radiation (e.g., photolithography process) can be used to create at least one channel within the polymer surface. In this manner, polymers with a variety of channel designs can be produced. Such ability allows methods of the present invention to produce various microfluidic devices. In some embodiments, various portions or areas of the channel(s) can be covalently attached with one or more surface modifying agent(s).

Another aspect of the present invention provides a single phase polymer derived from polymerizing a monomer mixture comprising a thiol monomer and an olefinic monomer, where the olefinic monomer comprises at least two olefinic compounds. In some embodiments within this aspect of the present invention, the olefinic monomer comprises a vinyl compound and a second olefinic compound selected from an acrylate compound, a methacrylate compound, and a mixture thereof. In other embodiments within this aspect of the present invention, the olefinic monomer comprises two vinyl compounds. Yet in some other embodiments within this aspect of the present invention, the monomer mixture further comprises an iniferter.

Still another aspect of the present invention provides a polymer derived from polymerizing a monomer mixture comprising a thiol monomer, an olefinic monomer, and optionally a filler, where the olefinic monomer comprises at least two olefinic compounds. The bulk matrix of the polymer consists essentially of a polymer network derived from the thiol monomer, the olefinic monomer, or a combination thereof, and the filler when optionally present. The term “filler” refers to any non-olefinic material that can be used to affect the chemical, mechanical, or physical property of the polymer. The filler does not phase separate upon polymerization of the monomeric mixture. Often the dispersion of filler is similar in the bulk polymer matrix as its dispersion within the monomer mixture that is polymerized. In some embodiments within this aspect of the present invention, the olefinic monomer comprises a vinyl compound and a second compound selected from an acrylate compound, a methacrylate compound, and a mixture thereof. Yet in other embodiments within this aspect of the present invention, the olefinic monomer consists of two different vinyl compounds. Still in other embodiments within this aspect of the present invention, the olefinic monomer consists of a vinyl compound and an acrylate compound. Yet in other embodiments within this aspect of the present invention, the olefinic monomer consists of a vinyl compound and a methacryalte compound.

Another aspect of the present invention provides polymers of unique material properties. Such polymers are typically produced by polymerizing a monomer mixture comprising a thiol monomer and an olefinic monomer comprising two or more olefinic compounds.

Some embodiments of the present invention provide a homogeneous polymer with high glass transition temperature and low shrinkage stress.

Yet in other embodiments, the olefinic monomer comprises a mixture of (i) primarily homopolymerizable olefinic monomers such as acrylates and methacrylates and (ii) primarily non-homopolymerizable olefinic monomers such as vinyl ether, allyl ether, vinyl silazane, maleates, and allyl isocyanurate.

Still in some other embodiments, a mixture of varying ratios of thiol and olefinic monomers form polymers with consistent or equivalent material properties.

Another aspect of the present invention provides a method for producing polymers, preferably homogeneous polymers, with low shrinkage stress and high glass transition temperatures.

### BRIEF DESCRIPTION OF THE DRAWINGS

FIG. 1 is a schematic representation of chemistry used to functionalize acrylate and thiol surfaces with grafting monomers;

FIGS. 2A and 2B are scanning electron microscope (SEM) images of a photopatterned polymer from a 50:50 mixture of TEGDA and urethane diacrylate with 1.5 wt % Irgacure 184 and 1.0 wt % TED;

FIGS. 3A and 3B are SEM images of photopatterned polymers of a 50:50 mixture of TEGDA and urethane diacrylate with 20 wt % pentaerythritol tetra-(3-mercaptopropionate) and 1.5 wt % Irgacure 184 and 1.0 wt % TED;

FIGS. 3C and 3D are SEM images of photopatterned polymers of a 50:50 mixture of TEGDA and urethane diacrylate with 20 wt % thiol and 0.5 wt % Irgacure 184;

FIGS. 4A and 4B are SEM images of a photopatterned polymer derived from a mixture of thiol-VE5015 with 0.5 wt % TED;

FIG. 5 is a graph showing comparison of photopolymerization rates of a various monomer(s) in the presence of 0.5 wt % photoiniferter XDT at an intensity of 5 mW/cm²;

FIG. 6 is a graph of showing the amount of polymer curing versus time in the presence of air;

FIG. 7 is a graph showing conversion kinetic comparison of trifluoroethyl acrylate monomer grafting on to polymers in the presence of photoiniferter and in the presence of photoinitiator;

FIG. 8A shows a graph of conversion kinetics for two different thicknesses of the trifluoroethyl acrylate monomer on substrates polymerized in the presence of 2 wt % photoiniferter XDT.

FIG. 8B is a normalized graph of FIG. 8A to account for thickness and total monomer amount;

FIG. 9A is a graph showing comparison of polymerization or grafting kinetics of PEG 375 monoacrylate on polymers that were made with (Δ) and without (□) photoiniferter;

FIG. 9B is a graph showing polymerization or grafting of PEG 375 monoacrylate monitored over an extended period of time on a polymer that was made without a photoiniferter;

FIG. 10 is a comparison graph of polymerization or grafting kinetics of PEG 375 monoacrylate on polymers that were made with different amounts of photoiniferter;

FIG. 11A is a comparison graph of conversion kinetics of grafting HDDA on three different polymers;

FIG. 11B is a close-up view of the first 300 seconds in FIG. 11A;

FIG. 12 is a graph showing kinetics of curing PEG 375 on pentaerythritol tetra(3-mercaptopropionate)-triazine isocyanurate (∘) polymer and urethane diacrylate/TEGDA (+) polymer both of which were made in the presence of 2 wt % XDT;

FIG. 13 is pentaerythritol tetra(3-mercaptopropionate)-triazine isocyanurate polymer photografted with PEG(375) monoacrylate for 900s;

FIGS. 14A and 14B are graphs showing glass transition temperatures of polymers derived from pentaerythritol tetra(3-mercaptopropionate) and triethyleneglycol divinylether, and pentaerythritol tetra(3-mercaptopropionate), triethyleneglycol divinylether, and tricyclodecane dimethanol diacrylate, respectively, at various thiol to olefin ratio;

FIG. 15A shows the photopolymerization kinetics of pentaerythritol tetra(3-mercaptopropionate) (∘), triethyleneglycol divinylether (□), and hexyl acrylate (Δ) mixture;

FIG. 15B show the photopolymerization kinetics of pentaerythiritol tetra(3-mercaptopropionate) (∘), triethyleneglycol divinylether (□), and triethyleneglycol dimethacrylate (Δ) mixture;

FIG. 16 is a comparison plot of shrinkage stress as a function of conversion (amount of polymerization) for a conventional methacrylate polymer with that of a polymer of the present invention;

FIG. 17 is a graph showing shrinkage stress as a function of time for a pure acrylate polymer (TDDDA) (— —) and a 1:1:2 thiol:ene:acrylate polymer (tetrathiol:divinyl ether:TDDDA) (—);

FIG. 18A is a loss tangent curve of thiol-ene-acrylate polymer of the present invention as a function of temperature; and

FIG. 18B is a loss tangent curve of a conventional acrylate polymer as a function of temperature.

### DETAILED DESCRIPTION OF THE INVENTION

Conventional polymer photolithography processes utilize polydimethylsiloxane (PDMS) polymers or derivatives thereof. Unfortunately, PDMS polymers have limited utility as a device material and exhibit poor mechanical integrity. Unless these polymers are treated with other components, they tend to swell in the presence of solvent, offer little resistance to solvent or solute diffusion, and lack robust surface modification techniques.

Some conventional photolithography processes use acrylates and/or methacrylate polymers. Unfortunately, these polymers often contain unreacted monomers. The presence of unreacted monomers in these polymers typically result in an offensive smell. As the polymer dries over time, the unreacted monomers diffuse out of the polymer matrix until the polymer is completely dry. Another drawback of the conventional acrylate and dimethacrylate based polymers is the negative effects of oxygen on the polymerization process, a phenomenon known as oxygen inhibition. Oxygen inhibition refers to the reaction of oxygen (from the ambient environment) with the functional groups of one or more of the monomers in acrylate and dimethacrylate derived polymers, before polymerization can be completed. Oxygen inhibition is believed to be one possible cause of the poor final conversion of these systems.

The present inventors have found that a polymer derived from a mixture of monomers (i.e., “monomer compositions”) comprising a thiol monomer and an olefinic monomer exhibits many of the desired mechanical and physical properties required for a wide variety of devices. In addition, the present inventors have found that polymers of the present invention are useful in photolithographic applications for a wide variety of polymeric devices. The term “mixture of monomers” refers to a mixture of compounds that results in a polymer formation under appropriate reaction conditions such as those disclosed herein. As such, the term can also include various initiators, fillers, and accelerators depending on the reaction conditions and/or application. For example, if photopolymerization using visible light is used for polymer formation, a mixture of monomers can also include visible light photoinitiators that are well known to one skilled in the art, such as camphorquinone. If ultraviolet photopolymerization is used for polymer formation, a mixture of monomers can also include UV photoinitiators that are well known to one skilled in the art, such as 2,2-dimethoxy-2-phenylacetophenone (DMPA). Suitable accelerators are also well known to one skilled in the art and include amine accelerators. It should be appreciated that some mixture of monomers need not include any accelerators, for example, polymerization can be readily initiated by camphorquinone without the presence of an amine accelerator. Absence of any amine accelerator in a monomer mixture is useful in producing biocompatible polymers since studies have shown that certain tertiary amine accelerators, such as N,N-dimethyl-p-toluidine, are carcinogenic and mutagenic.

The term “monomer” refers to any compound, oligomer, polymer, or molecule containing the functional group that is suitable for polymerization.

The term “thiol monomer” refers to a monomer mixture having one or more thiol compounds. As used herein, the term “thiol compound” refers to a compound having one or more thiol (—SH) functional groups that can undergo polymerization reaction. A thiol compound can be organic or inorganic compound as long as they are able to polymerize with an olefinic monomer as described herein. In many embodiments, thiol monomer is an organothiol monomer, i.e., a monomer mixture having one or more organothiol compound. The term “organothiol compound” refers to any of various organic compounds having one or more thiol functional groups. Typically, the organothiol compound has the general formula RSH, where R can be alkyl, alkenyl, cycloalkyl, cycloalkenyl, heteroalkyl, heteroalkenyl, aryl, heteroaryl, or a combination of two or more such groups, for example, cycloalkyl alkyl, aralkyl, heteroaralkyl, etc. Exemplary organothiol compounds include, but are not limited to, pentaerythritol tetramercaptopropionate (PETMP); 1-octanethiol; trimethylolpropane tris(3-mercaptopropionate); butyl 3-mercaptopropionate; 2,4,6-trioxo-1,3,5-triazina-triy (triethyl-tris (3-mercapto propionate); and 1,6-hexanedithiol. In some embodiments, thiol monomer has one thiol compound. In other embodiments, thiol monomer comprises two or more, (preferably two, three or four, more preferably two or three, and most preferably two) thiol compounds. In many embodiments, thiol compound is an organothiol compound.

The term “olefinic monomer” refers to a monomer mixture having one or more olefinic compounds. The term “olefinic compound” refers to a compound having one or more carbon-carbon double bonds that can undergo polymerization reaction. Exemplary olefinic compounds include, but are not limited to, acrylates and methacrylates (such as vinyl acrylate; triethyleneglycol dimethacrylate); triallyl-1,3,5-triazine-2,4,6-trione (TATATO); vinyl ethers [such as triethyleneglycol divinyl ether (TEGDVE) and dodecyl vinyl ether (DDVE)]; allyl ethers (such as trimethylolpropane diallyl ether); maleimides; and maleates as well as other olefinic compound that are known to one skilled in the art to undergo polymerization.

Unless the context requires otherwise, the terms “acrylate” and “acrylate compound” are used interchangeably herein and refer to a compound that has an acrylate (H₂C═CH—O₂—) moiety.

Unless the context requires otherwise, the terms “methacrylate” and “methacrylate compound” are used interchangeably herein and refer to a compound that has a methacrylate (H₂C═C(CH₃)—CO₂—) moiety.

Unless the context requires otherwise, the term “vinyl” and “vinyl compound” are used interchangeably herein and refer to a non-acrylate and non-methacrylate compound having a moiety of the formula H₂C═CH—.

In some embodiments, olefinic monomer has one olefinic compound. In such embodiments, the olefinic compound can be a vinyl compound, an acrylate or a methacrylate. In one specific embodiment, the olefinic compound is an acrylate. In another embodiment, the olefinic compound is a methacryalte. Still in another embodiment, the olefinic compound is a vinyl compound.

In other embodiments, olefinic monomer comprises two or more (preferably two, three or four) olefinic compounds. In such embodiments, each olefinic compounds is independently selected. Within these embodiments, one of the olefinic compound can be an acrylate, a methacrylate, or a vinyl compound. In some embodiments when olefinic monomer comprises two or more olefinic compounds, at least one of the olefinic compound is homopolymerizable (i.e., can itself form a polymer without the need for a co-monomer) and at least one of the olefinic compound is non-homopolymerizable. However, it should be appreciated that the scope of the present invention is not limited to such monomeric mixture. In fact, olefinic monomer comprising n olefinic compounds (where n is a total number of different olefinic compounds present in the olefinic monomer) can comprise from 0 to x olefinic compounds that are homopolymerizable (where 0≦x≦n) and y number of olefinic compounds that are non-homopolymerizable, where x+y=n.

In another embodiment, olefinic monomer comprises two olefinic compounds each of which is independently selected. In one particular example within this embodiment, the olefinic monomer comprises a vinyl compound and an acrylate or a methacrylate. In another specific example within this embodiment, the olefinic monomer comprises two vinyl compounds (i.e., two different vinyl compounds). Still in another example within this embodiment, the olefinic monomer comprises two different acrylates. Yet in another example within this embodiment, the olefinic monomer comprises two different methacrylates. In another example within this embodiment, the olefinic monomer comprises an acrylate and a methacrylate.

The amount of each components in the monomer mixture can vary significantly depending on desired polymer properties. The scope of present invention includes polymers produced from virtually any monomeric ratios. In one particular embodiment, the ratio of thiol monomer to olefinic monomer ranges from about 0.01 to about 100. In some instances, the amount of thiol monomer and olefinic monomer will depend on the composition of each monomeric mixture. For example, when the olefinic monomer consists of one olefinic compound, typically the ratio of thiol monomer to olefinic monomer is from about 1:99 to 99:1, typically from about 10:90 to 90:10, preferably from about 30:70 to 70:30, and more preferably about 50:50. Unless the otherwise stated or the context requires otherwise, the monomer ratio described herein refers to the ratio of polymerizable functional groups.

When the olefinic monomer comprises two or more olefinic compounds, the ratio of thiol monomer to olefinic monomer can range from 1:99 to 99:1, typically from about 5:95 to 95:5, preferably 10:90 to 90:10, more preferably from 20:80 to 80:20, and more preferably 20-40:80-60. In fact, unlike one olefinic compound composition of the olefinic monomer, when olefinic monomer includes two or more olefinic compound where at least one of the olefinic compound is co-polymerizable or homopolymerizable, the ratio of thiol monomer to non-homopolymerizable olefin compound need not be 1:1.

Polymers of the present invention are derived from polymerizing a mixture of monomers comprising a thiol monomer and an olefinic monomer. In one particular embodiment, the mixture of monomers further comprises an iniferter. Iniferters are initiators that induce radical polymerization that proceeds via initiation, propagation, radical termination, and transfer to initiator. Iniferters can be classified into several types: thermal or photoiniferters; monomeric, polymeric, or gel iniferters; monofunctional, difunctional, trifunctional, or polyfunctional iniferters; monomer or macromonomer iniferters; etc. Availability of a wide range of iniferters allow synthesis of various polymers, such as monofunctional, telechelic, block, graft, star, and crosslinked polymers, etc. Photoiniferters are compounds in which light is used to generate the free radical iniferter species. In one particular embodiment, the iniferter comprises a compound comprising at least one dithiocarbamate group. In other embodiments, the iniferter is of the formula: R¹—S—R²—S—R³, where R¹ and R³ are independently alkyl, aryl, aralkyl, alkylaryl, aralkylaryl, alkylarylalkyl, thiuram, xanthate, or carbamoyl; and R² is alkyl, aryl, aralkyl, alkylaryl, aralkylaryl, or alkylarylalkyl. Still in other embodiments, the iniferter comprises tetraethylthiuram disulphide, tetramethylthiuram disulphide, or p-xylene bis(N,N-diethyl dithiocarbamate) moiety.

Without being bound by any theory, it is believed that using a thiol monomer in polymerization reaction with an olefinic monomer such as an acrylate or a methacrylate monomer, results in a different type of polymerization reaction mechanism relative to the conventional acrylate and methacrylate based polymerization reactions. In addition, using a thiol monomer in a polymerization reaction results in polymers with different physical and/or mechanical characteristics than conventional polymers derived from acryaltes and methacrylates.

It is believed that the mixture of monomers and an iniferter generate a radical initiator upon photolysis, where the iniferter is a photoiniferter, or upon thermolysis, where the iniferter is thermally activated. Regardless of the mode of radical species generation, it is believed that the reaction mechanism step comprises growth reaction between a thiol monomer and an olefinic monomer. The reaction proceeds via propagation of a thiyl radical through a vinyl functional group. This reaction is believed to be followed by chain transfer of a hydrogen radical from the thiol monomer which regenerates the thiyl radical. The process then repeats for each radical generated by radical generation step. This successive propagation/chain transfer mechanism is believed to be the basis for thiol-olefin polymerizations and is schematically illustrated below.

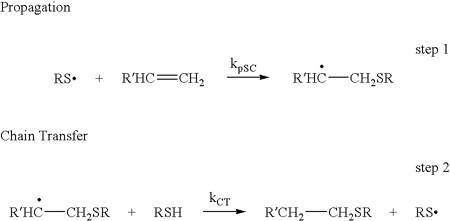

For thiol-olefin photopolymerizations in which the olefin monomer does not undergo significant homopolymerization, the propagation and chain transfer steps described above form the basis for the step-growth network. The thiol-vinyl ether, thiol-allyl ether, and thiol-norbornene systems are examples of step growth polymerization reaction mixtures.

Without being bound by any theory, in thiol-olefin polymerizations where the olefin monomer undergoes homopolymerization, the reaction mechanism is believed to be a combination of step and chain growth polymerizations. It is generally believed that the propagation mechanism for these systems includes a carbon radical propagation step (step 3, see below) in addition to the thiyl radical (e.g., RS•moiety) propagation and chain transfer steps (steps 1 and 2 above).

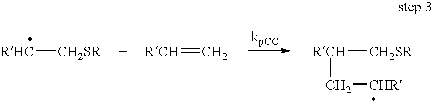

Therefore, in a thiol-(meth)acrylate polymerization, the network formation is believed to be through simultaneous chain growth polymerization of (meth)acrylate functional groups (step 3) and step growth polymerization of thiol-(meth)acrylate functionalities (Steps 1 and 2). It should be noted that the olefin compounds that do not homopolymerize are sometimes referred to herein as “enes.”

It is believed that the contribution of step growth mechanism in thiol-ene and thiol-(meth)acrylate polymerizations, the increase in molecular weight (i.e., “polymer growth”) in these polymers occurs relatively slowly leading to delayed gelation and hence formation of films or polymers having reduced shrinkage stresses. In addition, it is also believed that the rapid chain transfer ability of thiol functionalities, i.e., moieties, (see step 2) leads to quenching of peroxy radicals formed in the presence of oxygen thereby reducing oxygen inhibition of these polymerization reactions.

Thiol-olefin photopolymerizations have several highly desirable characteristics including rapid polymerization kinetics, lack of oxygen inhibition, delayed gelation, low volume shrinkage and the associated stress, good mechanical properties, and they are chemically versatile. Adding a thiol monomer to an acrylate or utilizing a thiol-olefin photopolymerization provides improved polymerization kinetics as well as polymer properties including the formation of well-defined polymer structures with higher aspect ratios. Accordingly, methods of the present invention provides production of smaller, more complicated, 2-dimensional and 3-dimensional polymeric structures and devices.

In addition, the presence of a thiol monomer enables a wider range of polymer chemistries and formulations leading to a wider range of polymer properties. Polymers of the present invention have increased solvent resistance, leading to decreased swelling and increased mechanical stability compared to conventional PDMS based polymers. Methods of the present invention provides polymers with enhanced properties including tailoring material properties for both rubbery and glassy materials formulations, as well as materials with up to two orders of magnitude difference in modulus.

Without being bound by any theory, it is believed that in some aspects of the present invention, a living radical polymerization (LRP) process is involved in polymer surface modification. As used herein, “surface” refers to any area of the polymer that is in contact with ambient atmosphere. Accordingly, for porous polymers the term “surface” includes interstitial surfaces which are the surfaces that surround and define the pores of the polymer. The living radical polymerization generally involves the polymerization, preferably photopolymerization, of monomers in the presence of an iniferters to create reactive surfaces that can be easily surface modified/grafted using a variety of surface modifying agent, e.g., vinyl monomer, chemistries thereby offering a variety of substrate surface properties. As stated above, iniferters are a class of initiators that induce radical polymerization that proceeds via initiation, propagation, primary radical termination, and transfer to initiator. Because bimolecular termination and other transfer reactions are generally negligible, these polymerizations are performed by the insertion of the monomer molecules into the iniferter bond, leading to polymers with two iniferter fragments at the chain ends.

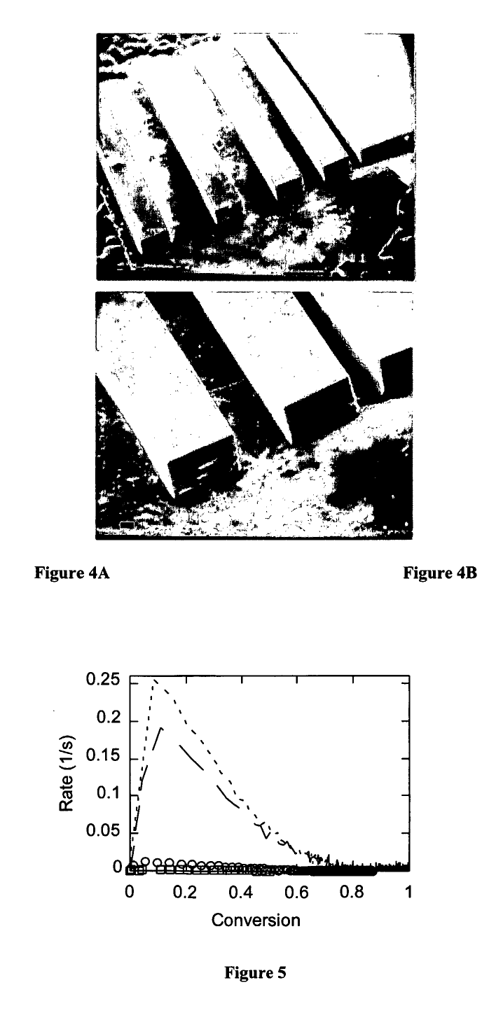

The use of iniferters gives polymers or oligomers bearing controlled end groups. The end groups of the polymers comprising an iniferter moiety can be used as another polymeric iniferter. In these cases, the iniferter moieties (C—S bond) are considered a dormant species of the initiating and propagating radicals. Unlike conventional polymers where the surface modification is limited by relatively extremely slow polymerization, in the presence of iniferters a mixture of monomers of the present invention polymerize at least one to two orders of magnitude faster than the traditional methacrylate based polymerization reaction. See FIG. 4. The accelerated polymerization of a mixture of monomers of the present invention in the presence of iniferters presents a rapid route to producing polymers (preferably in a controlled shape and form) while enabling subsequent surface modification.

Methods and monomeric mixtures of the present invention provide polymers of a wide variety of physical and mechanical properties, thus providing ability to tailor polymer bulk properties. Polymers having either glassy or rubbery networks, as well as polymers having over two orders of magnitude difference in the modulus while achieving breaking strains as high as 1800%, can be produced by methods of the present invention. For example, a pentaerythritol tetra-(3-mercaptopropionate)-triethylene glycol divinyl ether polymer has a glass transition temperature of −20° C., while a pentaerythritol tetra-(3-mercaptopropionate)-triazine isocyanurate polymer has a glass transition temperature of 48° C. The advantages of thiol-olefin curable monomer mixtures, coupled with their chemical versatility, make them useful in various applications. Accordingly, some aspects of the present invention provides ability to independently control polymer's surface properties and bulk characteristics. For example, the bulk characteristics is generally controlled by the initial monomeric mixture. Once the bulk polymer has formed that incorporates iniferter moieties on its surface, the polymer surface can be further modified as described herein, thereby allowing one to independently control surface properties and bulk properties of the polymer.

Another aspect of the present invention provides methods for producing or fabricating microdevices such as microfluidic devices. Microfluidic devices and methods for producing them are well known to one skilled in the art. See, for example, U.S. Patent Application Publication No. 20050129581, published Jun. 16, 2005, and references cited therein, all of which are incorporated herein by reference in their entirety. Microfluidic devices can be used to perform various chemical and biochemical analyses and syntheses, both for preparative and analytical applications. There are significant benefits to use of microfluidic devices because of their miniaturization in size. Such benefits include a substantial reduction in time, cost and the space requirements for the devices utilized to conduct the analysis or synthesis. Additionally, microfluidic devices have the potential to be adapted for use with automated systems, thereby providing the additional benefits of further cost reductions and decreased operator errors because of the reduction in human involvement. Microfluidic devices have been proposed for use in a variety of applications including, for instance, capillary electrophoresis, gas chromatography and cell separations.

Often each part of the microdevices, such as microfluidic devices, require different bulk properties and surface properties. Methods and polymers of the present invention provide control of the surface modification location (e.g., for grafting), density, and polymer bulk properties.

In some aspect of the present invention, mixtures of monomers of the present invention exhibit reduced shrinkage and shrinkage stress relative to other crosslinking monomer formulations. Without being bound by any theory, it is believed that this reduction in shrinkage and/or shrinkage stress is due to delayed gelation. Accordingly, methods of the present invention provide polymeric structures with smaller features and higher aspect ratios than conventional processes. For example, conventional acrylate based polymers have a theoretical maximum achievable aspect ratio of about 20 for a polymer structure that is about 300 μm in height. In contrast, in some embodiments of the present invention, there is no limit to the theoretically achievable aspect ratio using the monomer mixtures of the present invention. Typically, the theoretical maximum achievable aspect ratio of polymers of the present invention is at least about 10⁵, preferably about 10³, and more preferably about 10. The term “aspect ratio” refers to width to height ratio of the structured features.

It is believed that ability to produce superior structures (e.g., microdevices) using polymers of the present invention is due to a reduction in shrinkage stress relative to the conventional polymers. Structural (e.g., photopatterned polymer) aspect ratios are also believed to be limited by the ability to clean the resulting polymer with solvent. In contrast to conventional acrylate and methacrylate based polymers, polymers of the present invention have greater solvent resistance, thereby leading to enhanced structure capability.

Another advantageous aspect of the present invention is that the polymer cure time is significantly decreased. Typically, cure times for polymers of the present invention are decreased by 1 to 3 orders of magnitude relative to a similar conventional polymers that does not contain any thiol monomer component. Without being bound by any theory, it is believed that this reduction in cure time is due to increased polymerization kinetics of a thiol monomer and an olefinic monomer and/or a reduction in oxygen inhibition. Furthermore, a thiol monomer and an olefinic monomer mixture can be polymerized with little to no added photoinitiator, enabling fabrication of thicker polymer structures.

In addition to these formulations exhibiting reduced shrinkage and shrinkage stress, allowing for the production of smaller, more complicated, polymeric structures and devices, they also offer the advantages of bulk mechanical property control, as well as the ability to covalently surface modify for enhanced device functionality. These tailorable properties are particularly attractive in microfluidic devices, wherein the surface to volume ratio is very high. Surface modification can be utilized to enhance numerous features, including hydrophobicity, biocompatibility, catalyst loading, and anti-fouling capabilities.

The surface of polymers of the present invention can be modified by a variety of methods known to one skilled in the art. As used herein, the term “surface modification” when referring to a polymer refers to physically, but not mechanically, modifying the polymer surface structure (e.g., by formation of a channel, post, or other patterns including geometric features that extend out from the surface) and/or covalently attaching one or more surface modifying agents. As such, the term can refer to non-mechanical removal of a portion of the material from the polymer surface (e.g., photolithic formation of channels, or patterns within the polymer surface) and/or covalently attaching one or more surface modifying agents. The term “surface modifying agent” refers to a compound or a moiety that changes the chemical nature of the polymer surface. Exemplary surface modifying agents include, but are not limited to, proteins (such as antibodies and other amino acid oligomers), ligands (such as antigens), peptides (including oligopeptides), and nucleotides (including oligonucleotides and other nucleic acid sequences such as RNA and DNA along with oligomers thereof). The surface modifying agent can be attached directly to the polymer surface or it can be attached via a linker. Suitable linkers are well known to one skilled in the art and include polyethylene glycols (PEG) of various molecular weights.

The surface modifying agent can be detectably labeled. The term “detectably labeled” means that an agent (e.g., a probe) has been conjugated with a label that can be detected by physical, chemical, electromagnetic and other related analytical techniques. Examples of detectable labels that can be utilized include, but are not limited to, radioisotopes, fluorophores, chromophores, mass labels, electron dense particles, magnetic particles, spin labels, molecules that emit chemiluminescence, electrochemically active molecules, enzymes, cofactors, and enzyme substrates. In this manner, any interaction between a surface modifying agent and its corresponding complementary target can readily be determined using methods that are well known to one skilled in the art.

In some aspects of the present invention, polymers are derived by polymerizing a monomeric mixture comprising a thiol monomer and an olefinic monomer (“thiol-olefin polymer”). It has been found by the present inventors that these polymers can by modified by a photolithography process, which are well known to one skilled in the art. Briefly, a photolithography process comprises exposing the polymer surface to electromagnetic radiation (such as gamma ray, UV light, visible light, etc.) typically through a photomask. Depending on whether a positive or negative photolithography process is used, the exposed area is removed or retained when the polymer is processed after being exposed to electromagnetic radiation. Typically, negative photolithography process is used in methods of the present invention. In this manner, photolithography process can be used to provide a wide variety of structural patterns within the polymer surface.

In one aspect of the present invention, photolithography process can be used to form micro-patterns on the polymer surface. It has been found that exposure of thiol-olefin polymers of the present invention to UV light results in degradation of exposed polymer surface. Typically a photomask of a desired pattern is placed on top of the polymer surface prior to photolithography process. It is believed that electromagnetic radiation of sufficient energy (e.g., UV light) breaks the sulfur-carbon bond on the exposed surface, thereby resulting in formation of a desired pattern on the polymer surface. By layering two or more of the patterned (e.g., photopatterned) polymers on top of one another, one can fabricate a variety of microdevices, such as microfluidic devices.

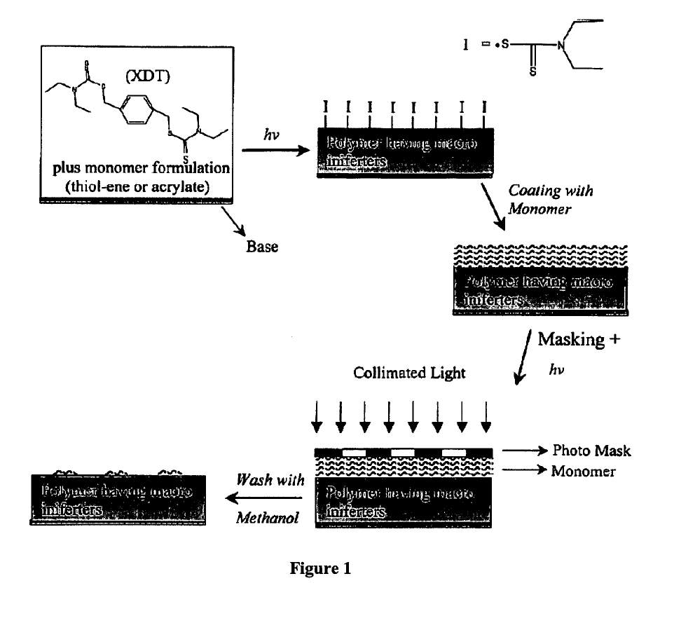

Another aspect of the present invention provides polymers derived from a monomeric mixture comprising a thiol monomer, an olefinic monomer, and an iniferter, preferably photoiniferter, (“thiol-olefin-iniferter polymer”). The thiol-olefin-iniferter polymers comprise surface bound iniferter moieties. The presence of iniferter moieties allows surfaces of these polymers to be readily modified using any of the suitable techniques known to one skilled in the art. One method of modifying the surface of these thiol-olefin-iniferter polymers is schematically illustrated in FIG. 1. It should be appreciated that while FIG. 1 illustrates a polymer having photoreactive surfaces that comprises dithiocarbamate (DTC) moiety on the polymer surface, methods of the present invention are not limited to DTC or even to photoiniferters. Surface modification methods disclosed herein can be readily modified to be adaptable to thermal iniferter as well as other photoiniferters.

Referring again to FIG. 1, photoiniferters based on dithiocarbamate (DTC) moiety are utilized to form photoreactive polymer surface, which is then employed to form photopatterned surfaces. Suitable photoiniferters include, but are not limited to, tetraethylarium disulfide (TED), XDT, and DTC-based salts such as sodium dimethyldithiocarbamate, as well as essentially compounds known to one skilled in the art that can covalently introduce DTC moiety into the polymer. As discussed in detail herein, the DTC moieties are then used for surface modification purposes.

In FIG. 1, monomeric mixture comprising a thiol monomer, an olefinic monomer, and a photoiniferter (XDT) is cured (i.e., polymerized) to form an iniferter-incorporated matrix as illustrated. The polymer is then washed (not shown), e.g., with deionized water and methanol, before coating with a second monomer (M). Photolithography, e.g., exploiting selective exposure to UV light through a photomask, is then used to form micro-patterns grafted on to the polymer surface. Upon illumination with UV light, the iniferter (I) moieties attached to the substrate cleave to give surface attached active carbon based radicals and propagating inactive DTC radicals. In the presence of a grafting monomer comprising an olefinic moiety, it is believed that these carbon-based radicals propagate and reversibly end cap with DTC radicals to form surface tethered polymer chains. In many cases, such as when the second monomer is a monoacrylate compound, the graft length can be controlled by the exposure time, further enhancing the degree of surface graft control. It should be appreciated that the second monomer can be coated with or tethered to a surface modifying agent. In this manner, the resulting polymer comprises a surface modifying agent such as proteins, antigens, ligands, nucleic acids, etc.

In some embodiments, methods of the present invention utilize or are related to what is commonly referred to as quasi-living radical photopolymerization (LRP). In many embodiments, such methods utilize a photoiniferter, such as photoiniferters comprising a dithiocarbamate (DTC) moiety. It is believed that upon exposure to electromagnetic radiation, e.g., UV light, the DTC based iniferters cleave into two fragments: a reactive carbon based radical and a less reactive sulfur based DTC radical. In the presence of an olefinic monomer “A”, the reactive radicals initiate a radical polymerization, forming propagating polymer radicals, which upon end capping with DTC radicals, produce a homopolymer of A. These end-capped, photolabile radicals can recleave upon further absorption of electromagnetic radiation of sufficient energy, e.g., UV light, to regenerate the reactive radical and the DTC radical. This type of reinitiation allows for a second monomer “B” to be sequentially polymerized to the reinitiated polymer ends of A to construct a block copolymer of AB. The length of the second monomer “B”, spatial resolution, grafting speeds and grafting density can be readily controlled by methods of the present invention.

Methods of the present invention have the advantages of traditional acrylate photopolymerization processes such as ambient curing, rapid polymerization, and solventless polymerization, as well as spatial and temporal control over the polymerization. In addition, methods of the present invention display advantageous capabilities such as rapid curing rates in the presence of very little or no photoinitiator and little inhibitory effects of oxygen. Furthermore, methods of the present invention provides polymers with low volume shrinkage, delayed gelation and concomitantly low stress development.

Additional objects, advantages, and novel features of this invention will become apparent to those skilled in the art upon examination of the following examples thereof, which are not intended to be limiting.

### EXAMPLES

### Materials

The photoinitiator, 2,2-dimethoxy-2-phenylacetophenone (DMPA), was purchased from Ciba-Geigy (Hawthorne, N.Y.). The photoiniferter, p-xylene bis(N,N-diethyl dithiocarbamate) (XDT), was obtained from 3M. The monomers pentaerythritol tetra-(3-mercaptopropionate), 1,6-hexanediol diacrylate (HDDA), polyethylene glycol (PEG 375) monoacrylate, triethylene glycol divinyl ether (DVE 3), Vectomer 5015 vinyl ether (VE-5015), and trifluoroethyl acrylate were purchased from Aldrich. The monomers, triethylene glycol diacrylate (TEGDA) and tetraethylene glycol dimethacrylate (TEGDMA), were purchased from Sartomer. An aromatic urethane diacrylate (Ebecryl 4827) was obtained from UCB Chemicals (Smyrna, Ga.). All monomers, photoiniferter, and the photoinitiator were used as received. Triazine isocyanurate (triazine) was also used as a monomer.

### FTIR

FTIR (Fourier Transform Infrared Spectroscopy) studies were conducted using a Nicolet 750 Magna FTIR spectrometer with a KBR beamsplitter and a DTGS detector. Initially, the IR specimen mold containing the sample was placed in a horizontal transmission apparatus, which was continuously purged with dry air. Then, series of scans were recorded, taking spectra at the rate of approximately 2 scans per second. Samples were irradiated until the reaction was complete, as indicated by the functional group absorption spectra no longer decreasing.

The DVE-3 and VE-5015 conversions were monitored using the carbon-carbon double bond absorption peak at 6192 cm⁻¹. TEGDA, HDDA, and TEGDMA conversions were monitored using the carbon-carbon double bond peaks at 6164 cm⁻¹. Trifluoroethyl acrylate conversions were monitored with double bond absorption peaks at 6182 cm⁻¹. Conversions were calculated using the ratio of peak areas before and after photopolymerization.

### Substrate and IR Mold Preparation

Substrates were prepared by photopolymerizing the base monomer on a clean, transparent glass slide under collimated UV light at 45 mW/cm² to full conversion. This reaction involved photopolymerization of the argon purged monomers in the presence of either a DTC based photoiniferter (XDT) or the photoinitiator, DMPA, to form a base layer having either iniferter or no iniferter, respectively. Contact photolithographic methods were used to photopolymerize the base layers onto glass slides. Polymerized base substrates were washed thoroughly with methanol and water to remove any unreacted monomer material.

The IR specimen mold was prepared using the above described substrate coated glass slide and a clean glass slide, with a metal spacer in between. The mold was clamped together, and the monomer solution was carefully pipetted from the open sides of the specimen mold, to avoid bubble formation. Further; metal spacers (thicknesses of 50 μm, 100 μm, and 200 μm) were used to control the thickness of monomer solution on top of the substrate. Photopolymerization of the monomers was initiated via an EXFO Acticure light source (EXFO, Mississauga, Ontario) with a 320-500 nm filter, and the polymerization kinetics were monitored with near FTIR. Irradiation intensities were measured with an International Light, Inc. Model IL1400A radiometer (Newburyport, Mass.).

### Micropattern Formation

Photoiniferters based on DTC groups were utilized to form photoreactive surfaces, which are then employed to form photopatterned surfaces. Monomer systems composed of either a thiol and an olefinic monomers or acrylate monomers were cured in the presence of an iniferter (XDT) to form an iniferter-incorporated matrix as illustrated in Scheme I. The substrates were then washed with deionized water and methanol before coating with monomer (M). Photolithography, exploiting selective exposure to UV light through a photomask, was used to form micro-patterns grafted on reactive surfaces. Upon illumination with UV light, the DTC moieties attached to the substrate cleave to give surface attached active carbon based radicals and propagating inactive DTC radicals. In the presence of a vinyl terminated grafting monomer, these carbon-based radicals propagate and reversibly end cap with DTC radicals to form surface tethered polymer chains. In the case of monoacrylates the graft length is controlled by the exposure time, further enhancing the degree of surface graft control.

### Example 1

This example illustrates a comparative photopatterning study of polymers derived from a mixture of monomers that does not contain any thiol monomer and polymers derived from a mixture of monomers that comprises a thiol monomer in accordance with the present invention.

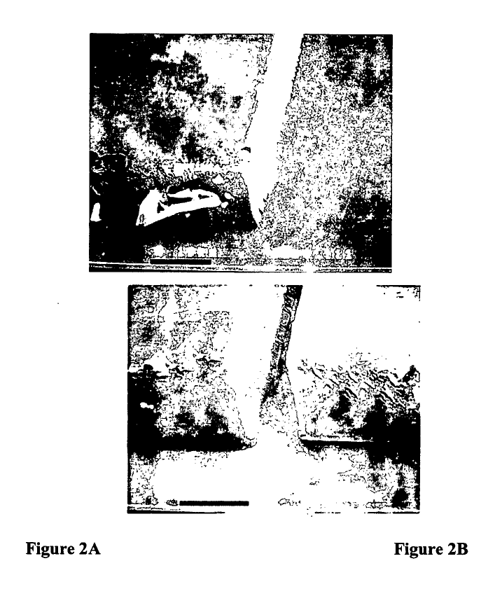

Two-dimensional polymeric structures formed from a urethane acrylate monomer formulation are shown in FIG. 2. The formulation for FIG. 2 consists of a 50:50 mixture of Ebecryl 4827 aromatic urethane diacrylate (Surface Specialties, UCB) and SR272* triethylene glycol diacrylate (Sartomer) with 1.5 wt % Irgacure 184 (Ciba Geigy) and 1.0 wt % tetraethylthiuram disulfide (TED) (Aldrich). It is believed that the structures in FIG. 2 are ridged due to shrinkage stress and bowed outwards at the base of the structures. These features are common in photopatterned structures derived from methacrylate monomer systems due to shrinkage stress and oxygen inhibition.

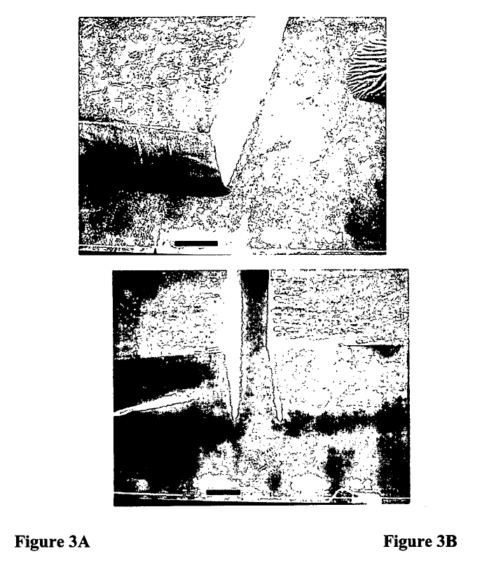

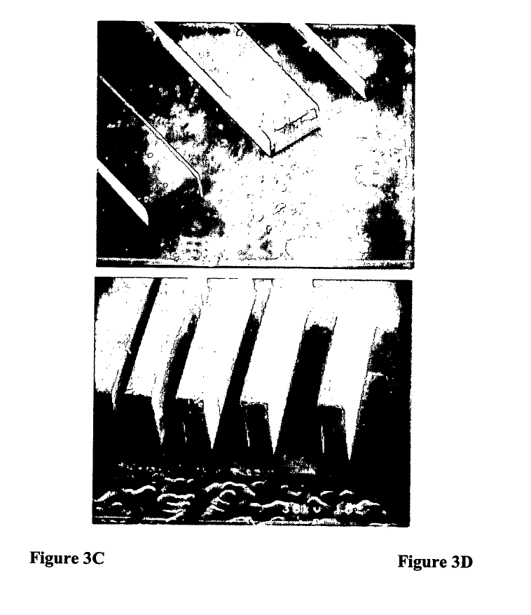

Polymerization of thiol monomer and acrylate monomer leads to delayed gelation relative to conventional methacrylate derived polymers. This delayed gelation in the mixture of monomers of the present invention results in the formation of polymer networks with reduced shrinkage stress. FIG. 3 illustrates the methacrylate polymer formulation as in FIG. 2, but with 20 wt % of a thiol monomer added to the formulation. In particular, the composition of monomers that formed the polymer of FIG. 3 was identical to that for FIG. 2, but with an added 20 wt % of pentaerythritol tetra-(3-mercaptopropionate) (Aldrich).

FIG. 4 illustrates photopatterned structures of the polymer derived from a 1:1 mixture (by functional group) of pentaerythritol tetra-(3-mercaptopropionate) and Vectomer 5015 Tris[4-(vinyloxy)butyl]trimellitate (Aldrich) with 0.1 wt % of the photoinitiator, 2,2-dimethoxy-2-phenylacetophenone. In all figures, black scale bars represent 100 μm.

In FIG. 3, where the thiol monomer was added to the methacrylate monomer, the resulting photopatterned structures were flat and smooth without any significant ridges and the base of the structures was not bowed. The structures in FIG. 4, a thiol monomer and an olefinic monomer formulations, also exhibited flatter/smoother surfaces without any significant ridges or bowed out features at the bottom interface.

### Example 2

### Formation of Reactive Substrates

### Thiol-Olefin Polymers Versus Acrylate Polymers

Experiments were conducted to investigate the curing kinetics of typical thiol-olefin polymers in the presence of photoiniferters and compared with those of typical acrylate and methacrylate polymerization rate under similar conditions. FIG. 5 shows the rate of various polymerization reactions in the presence of 0.5 wt % XDT, and at an irradiation intensity of 5 mW/cm². In FIG. 5, (- -) shows the polymerization rate of pentaerythritol tetra-(3-mercaptopropionate)-triethylene glycol divinyl ether mixture; (— —) shows the polymerization rate of pentaerythritol tetra-(3-mercaptopropionate)-Vectomer 5015 vinyl ether mixture; (∘) shows the polymerization rate of triethyleneglycol diaciylate; and (□) shows the polymerization rate of triethyleneglycol dimethacrylate.

As shown in FIG. 5, in the presence of XDT, the polymerization rate of mixtures comprising a thiol monomer was one to two orders of magnitude faster than conventional acrylate or methacrylate polymerization reaction. Further, while the mixtures comprising a thiol monomer achieved almost complete polymerization, polymerizations of the acrylate (TEGDA) and methacrylate (TEGDMA) gave lower final conversions (i.e., amount of polymerization) of 80% and 65%, respectively. High conversions achieved with the thiol-olefin mixture resulted in polymers having a significantly reduced concentration of leachable, residual, uncured monomers. This reduction is advantageous because uncured monomers often limit polymer applicability due to compatibility and mechanical failure. Specifically, for applications in which cells are in contact with the polymer, leachable monomers frequently lead to necrosis.

### Example 3

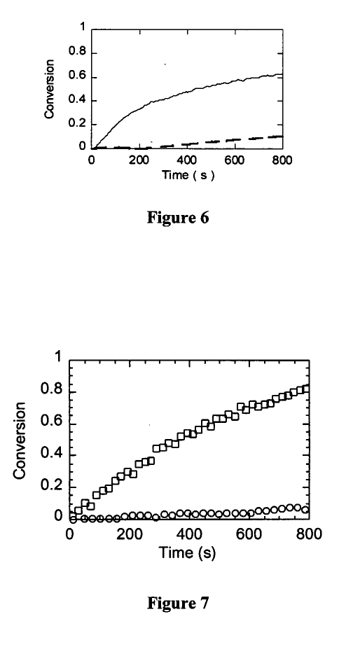

Polymerization rate of monomer compositions of the present invention are significantly less sensitive to oxygen inhibition. FIG. 6 is a graph showing the conversion (i.e., polymerization) versus time profiles for thiol-DVE3 and TEGDA systems containing 0.5 wt % XDT in the presence of air. Both samples were polymerized at an intensity of 5 mW/cm². In FIG. 6, (—) shows the rate of thiol-DVE3 polymerization and (— —) shows the rate of TEGDA polymerization. As can be seen, while the thiol-olefin monomer composition cures rapidly even in the presence of air, TEGDA shows significantly reduced conversion under these conditions.

### Example 4

Polymerization kinetics, initiated by surface tethered iniferters, were studied using near infrared spectroscopy. FIG. 7 shows the graph of conversion kinetics of trifluoroethyl acrylate monomer grafted on (i.e., covalently bonded) to polymers in the presence of 2 wt % photoiniferter XDT (□) and in the presence of 0.5 wt % photoinitiator DMPA (∘). The trifluoroethyl acrylate was polymerized on the polymer surfaces without additional photoinitiator added at an intensity of 40 mW/cm². The polymers were formed by polymerization of pentaerythritol tetra-(3-mercaptopropionate)-Vectomer 5015 vinyl ether mixture. As can be seen, the conversion versus time profiles of trifluoroethyl acrylate show that there is no significant polymerization or grafting on to a polymer having DMPA photoinitiator (0.5 wt %). In contrast, trifluoroethyl acrylate monomer polymerizes readily on to the polymer that was prepared in the presence of XDT. This difference in reactivity illustrates the polymerization initiating capabilities of the polymers that are terminated with photoiniferter (e.g., DTC) moieties.

### Example 5

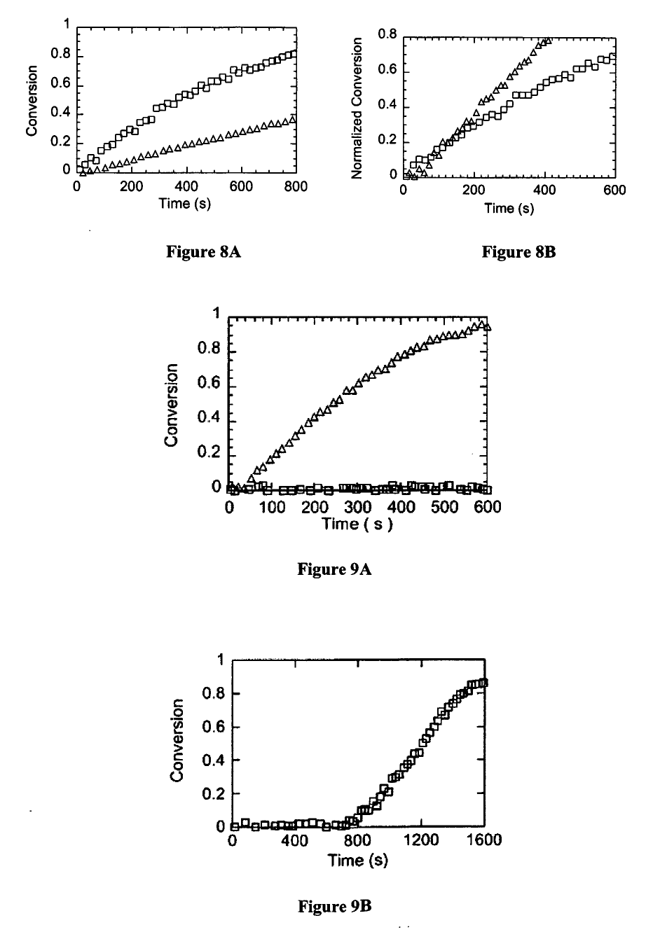

FIG. 8A shows the conversion graph of trifluoroethyl acrylate monomer (“graftable monomer”) on a polymer derived from a mixture of pentaerythritol tetra-(3-mercaptopropionate) and Vectomer 5015 vinyl ether in the presence of 2 wt % XDT, for two different amounts of graftable monomer on the substrate corresponding to thicknesses of 50 and 200 microns (□ and Δ, respectively). The monomer was cured on the surfaces without additional photoinitiator and was illuminated at an intensity of 40 mW/cm². Surfaces are prepared from stoichiometric ratios of pentaerythritol tetra-(3-mercaptopropionate) and Vectomer 5015 vinyl ether. As FIG. 8A shows, the rate of monomer conversion (i.e., polymerization on to the surface) is dependent on the amount of graftable monomer on the polymer surface. This phenomena of thickness dependent conversion is in direct contrast to what is expected from the kinetics of bulk initiated systems. However, for surface initiated polymerizations, the relative monomer conversion rates are expected to be dependent on the monomer thickness as the absolute polymerization does not change. Hence, the monomer conversion rate (i.e. that normalized by the total amount of monomer) should vary inversely with the monomer thickness.

The inverse thickness dependency of the monomer conversion rate is investigated by normalizing the monomer conversion (from FIG. 8A) with respect to the corresponding initial monomer thicknesses. Normalized conversions were obtained by keeping the conversion of the 50 micron thick monomer layer unchanged, while normalizing the 200 micron thick monomer layer was scaled by the corresponding thickness ratio relative to the 50 micron thick monomer layer. A plot of normalized conversions versus time (FIG. 8B) shows that these normalized conversions overlay for small conversions, thereby confirming the surface initiated nature of the polymerization. However, these conversions do not overlay for higher conversions (>35%), which is likely accounted for by the effects of chain transfer, irreversible termination, and a small amount of bulk, initiatorless polymerization, induced by the longer time exposure.

### Example 6

FIG. 9A shows a conversion kinetics comparison of PEG 375 monoacrylate on a polymer derived from a mixture of pentaerythritol tetra-(3-mercaptopropionate), triallyl-1,3,5-triazine-2,4,6-trione, and XDT with conversion kinetics on a polymer derived from a mixture of pentaerythritol tetra-(3-mercaptopropionate), triallyl-1,3,5-triazine-2,4,6-trione and DMPA photoinitiator (without XDT). It was observed that while PEG 375 monoacrylate did not significantly photopolymerize on the polymer that was prepared without XDT, it readily polymerized on the polymer containing DTC moieties.

Grafting of PEG 375 monoacrylate on polymer derived from a mixture of pentaerythritol tetra-(3-mercaptopropionate) and triallyl-1,3,5-triazine-2,4,6-trione in the absence of XDT were exposed to UV light for extended periods of time. As shown in FIG. 9B, while the monomers do not show any apparent polymerization at reduced exposure times, polymerization did occur after a prolonged exposure. However, curing studies of PEG 375 monoacrylate between two glass slides (results not shown) indicated that PEG 375 monoacrylate was not capable of undergoing any significant amount of polymerization under such photopolymerization conditions, even after 60 minutes of UV light exposure. Accordingly, it is believed that the polymerization observed on the polymer without any DTC moiety may be the result of PEG 375 monoacrylate diffusing into the polymer polymerizing due to unreacted DMPA or it may simply be diffusing into the polymer bulk material.

### Example 7

The ability to control the graft density of a modified surface is one of the important factors for controlling the surface properties of a polymer. As shown in FIG. 10, the amount of XDT used in initial polymer formation can be used to control the grafting density. In FIG. 10, the initial polymers were made by photopolymerization of pentaerythritol tetra-(3-mercaptopropionate) and triallyl-1,3,5-triazine-2,4,6-trione mixture. The monomer, PEG 375 monoacrylate, was cured on the polymer surface without any additional photoinitiator and illuminating at an intensity of 40 mW/cm². In FIG. 10, (∘) shows the grafting conversion rate for a polymer that was produced using 0.5 wt % of XDT and (□) shows the grafting conversion rate for a polymer that was produced using 2 wt % of XDT.

As shown in FIG. 10, PEG 375 monoacrylate exhibits a lower polymerization rate on polymers produced from a lower XDT amount (0.5 wt %) than on polymers produced from a relatively high iniferter concentrations (2 wt %). The higher grafting or secondary polymerization rates indicate that the grafting density is higher in polymers made from a higher amount of iniferter. FIG. 10 also shows that the inhibition time that occurs prior to substantial graft formation was reduced when grafting on polymers that had higher amount of DTC moieties.

### Example 8

This example illustrates the influence of polymer properties on their grafting characteristics.

Grafting studies were performed on a polymer made from a mixture of pentaerythritol tetra-(3-mercaptopropionate) and triethylene glycol divinyl ether (DVE3). This polymer is relatively rubbery in its property compared to polymers made from a mixture of pentaerythritol tetra-(3-mercaptopropionate) and triazine isocyanurate and a mixture of pentaerythritol tetra-(3-mercaptopropionate) and VE-5015.

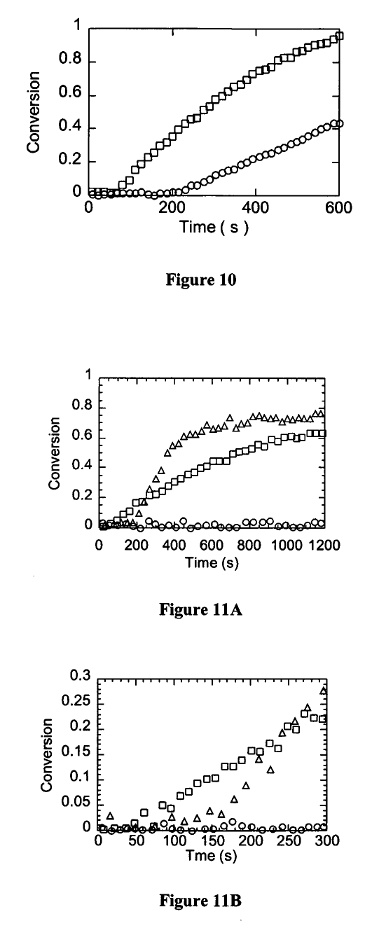

FIG. 11A shows the grafting or polymerization kinetics of 1,6-hexanediol diacrylate (HDDA) on a pentaerythritol tetra-(3-mercaptopropionate)-DVE3 polymers that was prepared in the presence of either XDT (□) or DMPA (Δ). It also shows the curing kinetics of HDDA between two glass slides (∘). HDDA was polymerized on the surfaces without additional photoinitiator and illuminated at an intensity of 40 mW/cm². FIG. 11B is a close-up view of FIG. 11A during the initial 300 seconds.

As can be seen in FIGS. 11A and 11B, HDDA did not appear to undergo any significant polymerization on glass slides; however, HDDA readily polymerized on pentaerythritol tetra-(3-mercaptopropionate)-DVE3 polymers that were prepared with and without XDT. The curing kinetics of HDDA between two glass slides clearly show that the monomer is incapable of undergoing homopolymerization under the polymer grafting conditions used. Again polymerization of HDDA on pentaerythritol tetra-(3-mercaptopropionate)-DVE3 polymer containing no DTC moieties may be due to diffusion of HDDA into the rubbery polymer bulk matrix and/or polymerization of HDDA due to unreacted DMPA that may be present in the polymer bulk matrix.

While HDDA cured on a pentaerythritol tetra(3-mercaptopropionate)-DVE3 polymer that was made without XDT, it did not polymerize (results not shown) under similar conditions on a relatively glassy polymer (pentaerythritol tetra(3-mercaptopropionate)-VE5015) indicating the polymer properties is a factor in determining the surface polymerization characteristics.

FIG. 11A also shows that HDDA achieved higher final conversion (grafting or surface polymerization) on pentaerythritol tetra(3-mercaptopropionate)-DVE3 polymers that do not contain any DTC moieties than on polymers that contain DTC moieties. Lower final polymerization of HDDA on polymers containing DTC moieties may be due to the cleaving of DTC moieties which, when present in HDDA, decrease the radical concentration in the bulk HDDA because of a possible reversible radical termination.

FIGS. 11A and 11B also show that HDDA appears to start polymerizing earlier on polymers that have DTC moieties on its surface. The reduced inhibition time in the polymerization of HDDA on polymer surfaces having DTC moieties is believed to be due to the DTC-based surface initiation process.

### Example 9

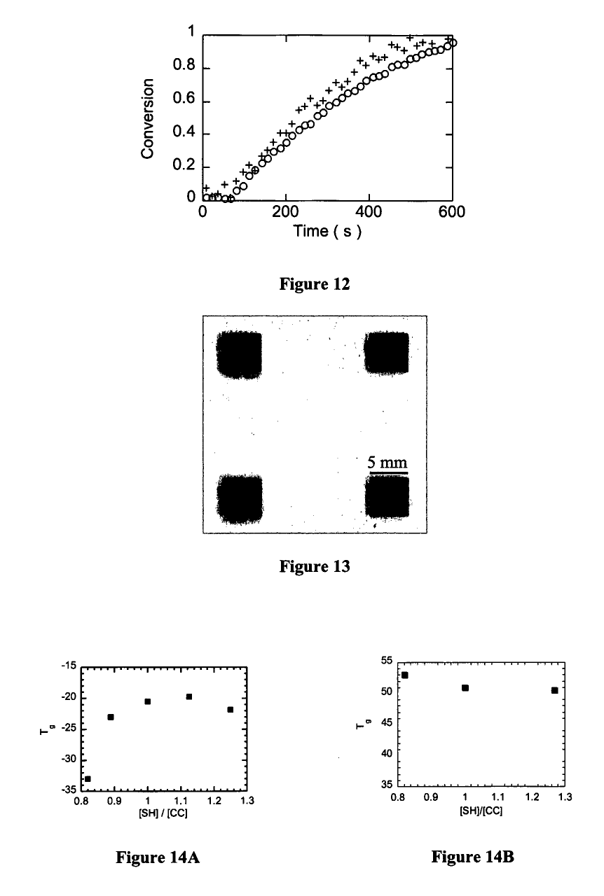

Experiments were conducted to comparing the surface grafting kinetics of XDT containing thiol-olefin polymers with acrylate polymers. FIG. 12 compares the curing or grafting kinetics of PEG 375 monoacrylate on a pentaerythritol tetra(3-mercaptopropionate)-triazine isocyanurate polymer with those on a urethane diacrylate/TEGDA polymer. Both polymers were prepared from a mixture comprising 2 wt % XDT. The monomer PEG 375 was cured on the polymer surfaces without any additional photoinitiator and was illuminated at an intensity of 40 mW/cm². The conversion versus time profiles indicate that PEG 375 grafts (i.e., covalently attaches to the polymer surface) at a similar rate on both the pentaerythritol tetra(3-mercaptopropionate)-triazine isocyanurate and urethane diacrylate/TEGDA polymers.

Photopatterning utilizing the XDT based LRP mechanism is shown in FIG. 13, where 1 cm² regions of PEG 375 monoacrylate were photografted on the pentaerythritol tetra(3-mercaptopropionate)-triazine isocyanurate polymer containing 0.5 wt % XDT. After rinsing with methanol and water, the PEG (375) grafted regions were stained red with hematoxylin to contrast the ungrafted substrate (clear) and the surface grafted pattern (stained in red). This sample was exposed to 45 mW/cm² light for 800 seconds using photolithographic techniques to assure that grafting had occurred only in the exposed regions. The contact angle of the grafted areas was approximately 10° using conventional goniometry, which contrasts the polymer contact angle of 45°. A similar photolithographic technique was utilized to modify DTC incorporated pentaerythritol tetra(3-mercaptopropionate)-triazine isocyanurate polymer surfaces by photografting with trifluoroethyl acrylate, resulting in a hydrophobic surface having a contact angle of 80° (result not shown).

Utilizing iniferters, e.g., DTC, that are attached to polymer surface to initiate further polymerization allows polymers of the present invention to be tailored for chemical and/or biological surface interactions. Applications requiring controlled cell adhesion, hydrophobic/hydrophilic interactions, protein attachment, drug delivery, sensory responses, or surface fluorescence, among others, can be achieved with polymers of the present invention. Moreover, photolithographically controlled grafting disclosed herein provides the patterning of multiple surface chemistries and hence allows spatial and temporal control over polymer surface properties.

### Example 10

Properties of various polymers of the present invention were compared. FIGS. 14A and 14B show the glass transition temperatures of polymers made from various thiol-olefin mixtures of the present invention, where [SH]/[CC] represents the ratio of thiol monomer to olefinic monomer. In particular, FIG. 14A is a graph of glass transition temperature of polymers derived (i.e., made) from various amounts of pentaerythritol tetra(3-mercaptopropionate) and triethyleneglycol divinylether, and FIG. 14B is a graph of glass transition temperature of polymers derived from various amounts of pentaerythritol tetra(3-mercaptopropionate), triethyleneglycol divinylether, and tricyclodecane dimethanol diacrylate. In FIG. 14B, the amount of tricyclodecane dimethanol diacrylate was kept constant at 50% by weight. As can be seen in FIGS. 14A and 14B, polymers having both a vinyl compound and a methacrylate compound in the olefinic monomer mixture have relatively constant material properties (i.e., glass transition temperature), whereas the glass transition temperature of polymers having one vinyl compound in the olefinic monomer varies significantly depending on the ratio of the thiol monomer and the olefinic monomer. Therefore, polymers with a wide variety of properties can be produced by the present invention.

### Example 11

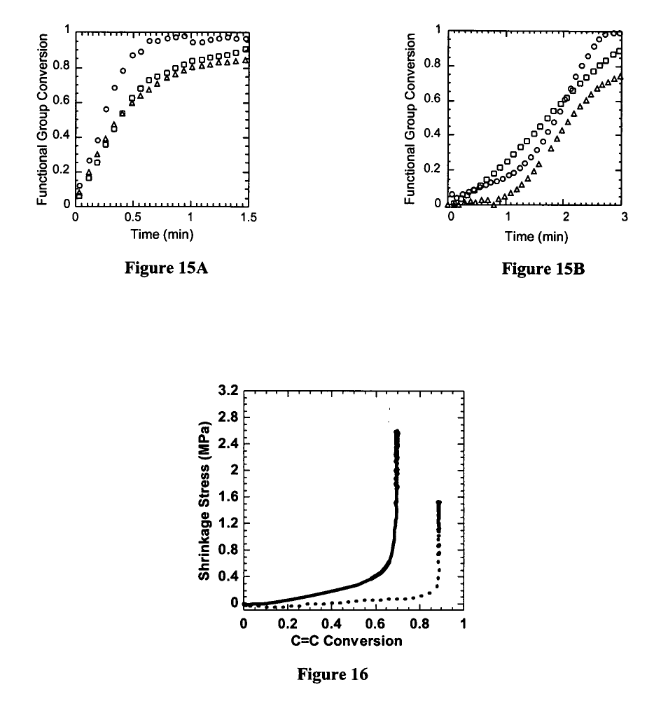

FIGS. 15A and 15B show the photopolymerization kinetics of(1) pentaerythritol tetra(3-mercaptopropionate) (∘), triethyleneglycol divinylether (□), and hexyl acrylate (Δ) mixture, and (2) pentaerythritol tetra(3-mercaptopropionate) (∘), triethyleneglycol divinylether (□), and triethyleneglycol dimethacrylate (Δ) mixture, respectively. Sample (1) contained 0.1 wt % 2,2-dimethoxy-2-phenylacetophenone and was irradiated at 2 mW/cm². Sample (2) contained 0.1 wt % 2,2-dimethoxy-2-phenylacetophenone and was irradiated at 4 mW/cm².

As can be seen in FIGS. 15A and 15B, generally all the monomers in these mixtures achieve high conversions. Without being bound by any theory, it is believed that the high conversion rates in these mixtures can be explained by considering the reaction mechanism of a general ternary thiol-ene-(meth)acrylate system (steps 4-10) and the experimentally derived kinetic constants. When olefinic monomer comprises two olefinic compounds, where one of the olefinic compound is homopolymerizable (i.e., can itself form a polymer without the need for a co-monomer) and the other olefinic compound is non-homopolymerizable, the reaction (i.e., polymerization) mechanism can further include steps 4-10 shown below, in addition to steps 1-3 discussed herein:

Events in which a thiol monomer is consumed:

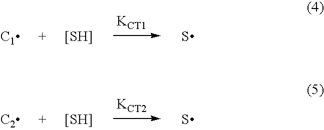

Events in which the vinyl monomer-1, [CC]₁ (ene functionality) is consumed:

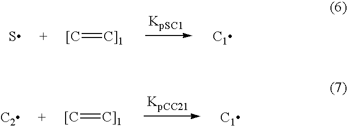

Events in which the vinyl monomer-2, [CC]₂ ((meth) functionality) is consumed:

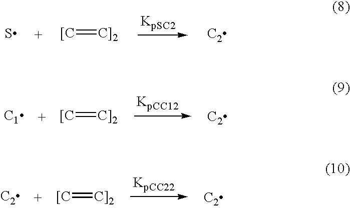

Table I presents experimentally derived kinetic constants for a thiol-vinyl ether-acrylate mixture.

TABLE I
Propagation and termination parameters that were used for predicting
the ternary thiol-vinyl ether-acrylate network structures.

| k_{CT1} | 2.1 × 10⁶ | L/mo.s |
|---|---|---|
| k_{pSC1} | 2.6 × 10⁶ | L/mo.s |
| k_{pCC11} | Negligible | |
| k_{pCC12} | 1.0 × 10⁵ | L/mol.s |
| k_{CT2} | 0.8 × 10⁵ | L/mol.s |
| k_{pSC2} | 1.2 × 10⁵ | L/mol.s |
| k_{pCC22} | 1.15 × 10⁵ | L/mol.s |
| k_{pCC21} | 0.25 × 10⁵ | L/mol.s |

While it is believed that the acrylic radical prefers to homopolymerize (k_{pCC22}>k_{pCC21} and k_{CT2}), the thiyl and ene functionalities also prefer to copolymerize amongst themselves (k_{pSC1}>k_{pSC2} and k_{CT1}>k_{pCC12}), thereby leading to relatively equal conversions of the thiol, ene, and acrylate functional groups. Similar behavior is also believed to be true for other thiol-ene-(meth)acrylate mixtures.

### Example 12

Polymers of the present invention have many advantageous properties. For example, as shown in FIG. 16, polymers of the present invention have greatly reduced shrinkage stress compared to that of the conventional methacrylate polymer. Monomeric mixtures for producing the polymers are disclosed in Table 2 below. In addition, the delayed gelation aspect of monomeric mixtures of the present invention was also apparent from the fact that shrinkage stress built up slowly and appearing only after high double bond conversion (i.e., polymerization). Shown in Table 2 below are the glass transition temperatures (T_{g}) and T_{g} width at half maximum of the polymers shown in FIG. 16.

TABLE 2
Glass transition temperature (T_{g}) and its width at half maximum.

| Polymer | T_{g} | T_{g} width @ ½ maximum |
|---|---|---|
| (ethoxylated bisphenol A | 85° C. | ~100° C. |
| dimethacrylate/triethyleneglycol | | |
| dimethacrylate) | | |
| (ethoxylated bisphenol A | 80° C. | 55° C. |
| dimethacrylate/pentaerythritol | | |
| tetra(3-mercaptopropionate)/ | | |
| triazine isocyanurate) | | |

This data shows that while the glass transition temperature of some of the polymers of the present invention is slightly less than that of conventional pure methacrylate polymers, the T_{g} width of some the polymers of the present invention is much less compared to that of conventional methacrylate polymers.

### Example 13

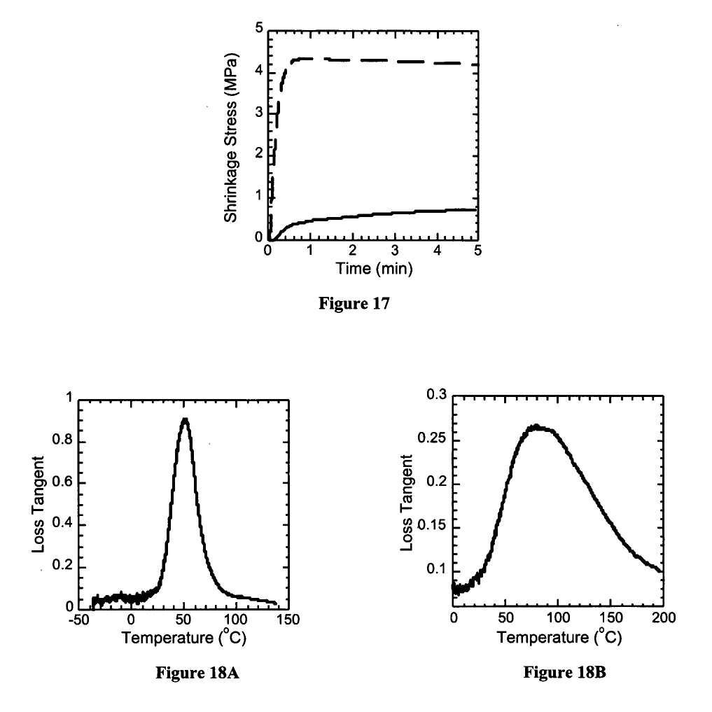

A similar behavior was also observed for polymers of the present invention comprising an acrylate instead of methacrylate. FIG. 17 shows the shrinkage stress for a conventional pure acrylate polymer and its corresponding polymer of the present invention comprising thiol-ene-acrylate. In FIG. 17, (— —) represents shrinkage stress of tricyclodecane dimethanol diacrylate polymer and (—) represents shrinkage stress of a polymer made from a 1:1:2 mixture of pentaerythritol tetra(3-mercaptopropionate): triethyleneglycol divinylether: tricyclodecane dimethanol diacrylate.

FIGS. 18A and 18B show loss tangent curves of a polymer derived from 1:1:2 mixture of pentaerythritol tetra(3-mercaptopropionate): triethyleneglycol divinylether: tricyclodecane dimethanol diacrylate, and that of a conventional tricyclodecane dimethanol diacrylate polymer, respectively. As can be seen, similar to the thiol-ene-methacrylate polymer (see Example 12), the thiol-ene-acrylate polymers of the present invention also have greatly reduced shrinkage stress while exhibiting greatly reduced T_{g} widths and high T_{g}.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A polymer derived from polymerizing a mixture of monomers comprising a thiol monomer, an olefinic monomer, and an iniferter.

2. The polymer of claim 1, wherein said olefinic monomer comprises an acrylate compound, a methacrylate compound, a vinyl ether compound, an allyl ether compound, a vinyl silazane compound, a maleate compound, a maleimide compound, a furmarate compound, an allyl isocyanurate compound, a norbornene compound, or a mixture of two or more thereof.

3. The polymer of claim 1, wherein said olefinic monomer comprises at least two different olefinic compounds.

4. The polymer of claim 3, wherein said olefinic monomer consists of two different olefin compounds.

5. The polymer of claim 3, wherein said olefinic monomer comprises a vinyl compound and a second compound selected from the group consisting of an acrylate, a methacrylate, and a mixture thereof.

6. The polymer of claim 3, wherein said olefinic monomer comprises two different acrylates.

7. The polymer of claim 3, wherein said olefinic monomer comprises two different methacrylates.

8. The polymer of claim 3, wherein said olefinic monomer comprises an acrylate and a methacrylate.

9. The polymer of claim 1, wherein the ratio of said thiol monomer to said olefinic monomer in said mixture ranges from about 0.01 to about 100.

10. The polymer of claim 1, wherein said mixture is polymerized using an electromagnetic radiation.

11. The polymer of claim 1, wherein said iniferter is a photoiniferter.

12. The polymer of claim 1, wherein at least a portion of said polymer surface comprises an iniferter moiety.

13. A method for modifying a surface of a polymer derived from a mixture comprising a thiol monomer and an olefinic monomer, said method comprising exposing at least a portion of the polymer surface to electromagnetic radiation of sufficient energy to modify the polymer surface.

14. The method of claim 13, wherein the mixture further comprises a photoiniferter.

15. The method of claim 14, wherein at least a portion of the polymer surface comprises a photoiniferter moiety.

16. The method of claim 15 further comprising covalently attaching a surface modifier to at least a portion of the surface comprising the photoiniferter moiety.

17. The method of claim 16, wherein the surface modifier is covalently attached to the polymer surface by a photolithography process.

18. The method of claim 13, wherein said method creates at least one channel within the polymer surface.

19. A microfluidic device comprising a polymer in which a surface of said polymer has been modified compared to a bulk matrix of said polymer, wherein said polymer is derived from a polymerization of a mixture comprising a thiol monomer and an olefinic monomer, and wherein said surface has been modified by a photolithography process.

20. The method of claim 19, wherein said polymer surface comprises a plurality of channels.

21. The method of claim 19, wherein said polymer surface comprises a covalently attached surface modifying agent.

22. A single phase polymer derived from polymerizing a monomer mixture comprising a thiol monomer and an olefinic monomer, wherein said olefinic monomer comprises at least two olefinic compounds.

23. The polymer of claim 22, wherein said olefinic monomer comprises a vinyl compound and a second olefinic compound selected from the group consisting of an acrylate compound, a methacrylate compound, and a mixture thereof.

24. The polymer of claim 22, wherein said olefinic monomer comprises two vinyl compounds.

25. The polymer of claim 22, wherein said monomer mixture further comprises an iniferter.

26. A polymer derived from polymerizing a monomer mixture comprising a thiol monomer, an olefinic monomer, and optionally a filler, wherein said olefinic monomer comprises at least two olefinic compounds, and wherein the bulk matrix of said polymer consists essentially of a polymer network derived from said thiol monomer, olefinic monomer, or a combination thereof, and the filler when optionally present.

27. The polymer of claim 26, wherein said olefinic monomer comprises a vinyl compound and a second compound selected from the group consisting of an acrylate compound, a methacrylate compound, and a mixture thereof.

28. The polymer of claim 26, wherein said olefinic monomer consists of two different vinyl compounds.

29. The polymer of claim 26, wherein said olefinic monomer consists of a vinyl compound and an acrylate compound.

30. The polymer of claim 26, wherein said olefinic monomer consists of a vinyl compound and a methacryalte compound.
